(19) United States
(12) Patent Application Publication
(10) Pub. No.: US 2025/0175829 A1
(43) Pub. Date: May 29, 2025

(54) MEASUREMENT GAP IN A CENTRALIZED UNIT AND DISTRIBUTED UNIT SPLIT

(71) Applicant: ZTE Corporation, Shenzhen (CN)

(72) Inventors: Mengjie ZHANG, Shenzhen (CN); Jing LIU, Shenzhen (CN); Jianxun AI, Shenzhen (CN); Yin GAO, Shenzhen (CN); Jiren HAN, Shenzhen (CN)

(21) Appl. No.: 19/039,157

(22) Filed: Jan. 28, 2025

Related U.S. Application Data
(63) Continuation of application No. PCT/CN2022/109212, filed on Jul. 29, 2022.

(51) Int. Cl. H04W 24/08; H04W 76/20

(52) U.S. Cl. CPC H04W 24/08; H04W 76/20

(57) ABSTRACT

Wireless communications when there is a centralized unit (CU) split from a distributed unit (DU) may be modified to coordinate communication for measurement gaps. The coordination may include a measurement gap configuration. Gap information may be used between the CU, DU, and the user equipment (UE). The information may include a gap type, such as a concurrent gap, a pre-configured gap, or a network controlled small gap (NCSG). The embodiments include communication examples for handling the measurement gap with a split CU and DU.

### CROSS-REFERENCE TO RELATED APPLICATIONS

This application is a continuation application of, and claims the benefits of, International Patent Application No. PCT/CN2022/109212, filed Jul. 29, 2022, published as PCT publication No. WO/2024/021113 on Feb. 1, 2024, the disclosure of which is incorporated herein by reference in its entirety.

### TECHNICAL FIELD

This document is directed generally to wireless communications. More specifically, in a mobile device communications system, there may be improved communications for measurement gaps.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

### SUMMARY

This document relates to methods, systems, and devices for wireless communications in which there is a centralized unit (CU) split from a distributed unit (DU). Despite the split, there may be coordination for measurement gaps. The coordination may include a measurement gap configuration. Gap information may be used between the CU, DU, and the user equipment (UE). The information may include a gap type, such as a concurrent gap, a pre-configured gap, or a network controlled small gap (NCSG). The embodiments include communication examples for handling the measurement gap with a split CU and DU.

In one embodiment, a method for wireless communication includes sending a request message with a gap information; and receiving a response message with a gap configuration based on the gap information. The sending is from a base station centralized unit (CU) to a base station distributed unit (DU), and the response is received by the base station CU from the base station DU. The gap is a period that a user equipment (UE) uses to perform measurements or operations with a dedicated use case. The request message comprises a user equipment (UE) context setup request message or a UE context modification request message, wherein the response message comprises a UE context setup response message or a UE context modification response message. The gap information comprises a requested or allowed gap type, a requested or allowed gap purpose, or a requested or allowed gap pattern, a requested or allowed number of gap patterns, a requested or allowed gap combination information, or a gap priority information. The gap type comprises at least one of the following: a concurrent gap, a pre-configured gap, or a network controlled small gap (NCSG). The gap purpose or gap pattern comprises at least one of the following: a per frequency range (FR) 1 gap, a per FR2 gap or a per UE gap. The gap combination information comprises at least one of the following: a bit string or a bitmap, each position in the bit string or the bitmap indicates whether the corresponding gap combination is requested or not, or at least one gap combination index. The gap priority information comprises at least one of the following: one or a list of gap priority for the gap associated with a dedicated use case; one or a list of gap priority for the gap used for a associated measurement frequency or a measurement object. The gap information comprises at least one of a need for gap (NeedForGap) information or a network controlled small gap (NCSG) information, to indicate whether a measurement gap or a NCSG is required for a UE to perform measurements on a target band. The need for gap information and the NCSG information is encapsulated as an OCTET STRING or a container within the request message. The method further includes determining, by the CU, a gap association based on the gap configuration. The method further includes receiving, by the CU from the DU, a gap association, wherein the gap association is determined by the DU based on the gap configuration. The gap association is for at least one of the following: a measurement gap being associated with a measurement object, or a measurement gap being associated with a dedicated use case. The use case comprises at least one of the following: Positioning Reference Signaling (PRS) measurement, Multi-Universal Subscriber Identity Module (MUSIM), Non-Terrestrial Network (NTN) gap, Synchronization Signal Block (SSB) measurement, Channel State Information Reference Signaling (CSI-RS) measurement, or E-UTRAN measurement.

In one embodiment, a method for wireless communication includes receiving a request message with a gap information; and transmitting a response message with a gap configuration based on the gap information. The receiving is by a base station distributed unit (DU) from a base station centralized unit (CU), and the transmitting is from the base station DU to the base station CU. The gap is a period that a user equipment (UE) uses to perform measurements or operation with a dedicated use case. The request message comprises a user equipment (UE) context setup request message or a UE context modification request message, wherein the response message comprises a UE context setup response message or a UE context modification response message. The gap information comprises a requested or allowed gap type, a requested or allowed gap purpose, a requested or allowed gap pattern, a requested or allowed number of gap patterns, a requested or allowed gap combination information, or a gap priority information. The gap type comprises at least one of the following: a concurrent gap, a pre-configured gap, or a network controlled small gap (NCSG). The gap purpose or gap pattern comprises at least one of the following: a per frequency range (FR) 1 gap, a per FR2 gap or a per UE gap. The gap combination information comprises at least one of the following: a bit string or a bitmap, each position in the bit string or the bitmap indicates whether the corresponding gap combination is requested or not, or at least one gap combination index. The gap priority information comprises at least one of the following: one or a list of gap priority for the gap associated with a dedicated use case; one or a list of gap priority for the gap used for an associated measurement frequency or a measurement object. The gap information comprises at least one of a need for gap (NeedForGap) information or a network controlled small gap (NCSG) information, to indicate whether a measurement gap or a NCSG is required for a user equipment (UE) to perform measurements on a target band. The need for gap information and the NCSG information is encapsulated as an OCTET STRING or a container within the request message. The method further includes determining, by the CU, a gap association based on the gap configuration. The method further includes determining, by the DU, a gap association based on the gap configuration; and sending, by the DU to the CU, the gap association. The gap association is for at least one of the following: a measurement gap being associated with a measurement object, or a measurement gap being associated with a dedicated use case. The use case comprises at least one of the following: Positioning Reference Signaling (PRS) measurement, Multi-Universal Subscriber Identity Module (MUSIM), Non-Terrestrial Network (NTN) gap, Synchronization Signal Block (SSB) measurement, Channel State Signaling (CSI-RS) measurement, or E-UTRAN measurement.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example base station.

FIG. 2 shows an example random access (RA) messaging environment.

FIG. 3 shows a network architecture of a base station Central Unit (CU) and base station Distributed Unit (DU).

FIG. 4 shows one embodiment of communications for a split embodiment of a Distributed Unit (DU) and Centralized Unit (CU).

FIG. 5 shows another embodiment of communications for a split embodiment of a Distributed Unit (DU) and Centralized Unit (CU).

FIG. 6 shows another embodiment of communications for a split embodiment of a Distributed Unit (DU) and Centralized Unit (CU).

FIG. 7 shows another embodiment of communications for a split embodiment of a Distributed Unit (DU) and Centralized Unit (CU).

FIG. 8 shows another embodiment of communications for a split embodiment of a Distributed Unit (DU) and Centralized Unit (CU).

FIG. 9 shows another embodiment of communications for a split embodiment of a Distributed Unit (DU) and Centralized Unit (CU).

FIG. 10 shows another embodiment of communications for a split embodiment of a Distributed Unit (DU) and Centralized Unit (CU).

FIG. 11 shows a measurement gap timing example.

FIG. 12 shows an embodiment of communications for a split embodiment of a Distributed Unit (DU) and Centralized Unit (CU).

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the base station at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The base station or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

There may be a master node (“MN”) and one or more secondary nodes (“SN”). The MN may include a master cell group (“MCG”) and the SN may each include a secondary cell group (“SCG”). The MCG is the group of cells provided by the master node (“MN”) and the SCG is the group of cells provided by the secondary node (“SN”). The MCG may include a primary cell (“PCell”) and one or more secondary cells (“SCell”). The SCG may include a primary secondary cell (“PSCell”) and one or more secondary cells (“SCell”). Each primary cell may be connected with multiple secondary cells. The primary cells (PCell, PSCell) are the master cells of their respective groups (MCG, SCG, respectively) and may initiate initial access. The primary cells may be used for signaling and may be referred to as special cell (“spCell”) where spCell=PCell+PSCell. The mobility between cells described in these embodiments may be based on the PCell, PSCell, and/or SCell. However, as described, they may be referred to as a source cell and a target cell. A user equipment (“UE”) device may move between nodes or cells in which case a handover or a change/addition operation may occur to improve network reliability for the UE as it moves from a source cell to a target cell.

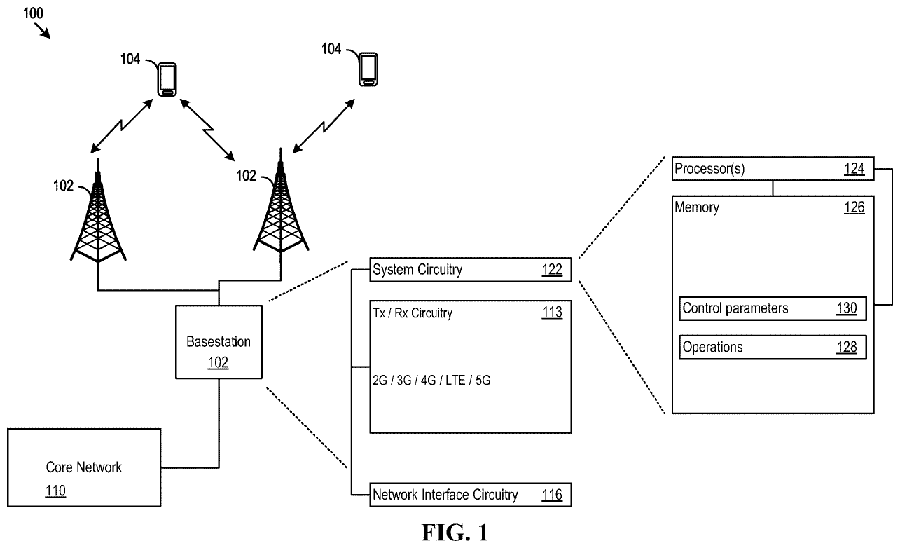

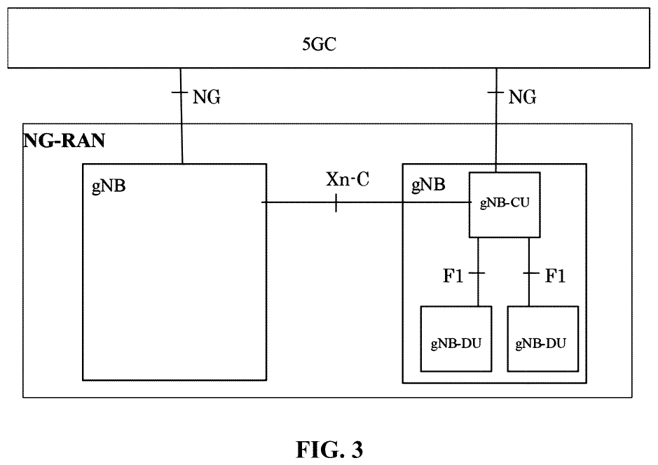

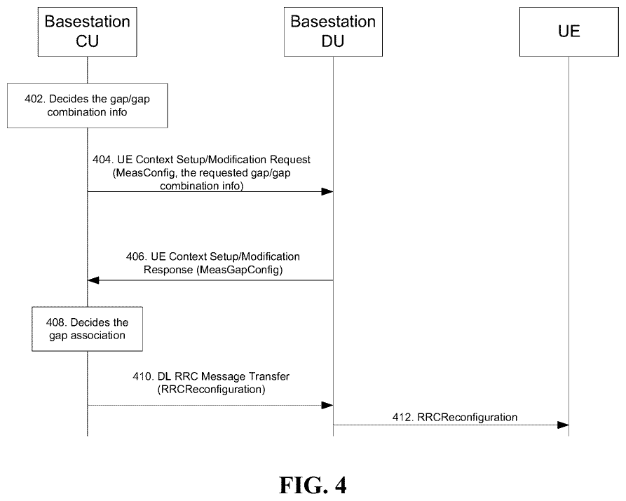

As described below with respect to FIGS. 1-3, a network provider may include a number of network nodes (i.e. base stations) for providing network access to a user equipment (“UE”) device. The network nodes are referred to as base stations in some embodiments. When there is a centralized unit (CU) base station split from a distributed unit (DU) base station, the CU or DU may communicate gap information for coordinating gap measurement. In CU/DU split case, the CU may coordinate some measurement gap assistance information with the DU to help the DU generate the measurement gap configuration. The DU may respond with measurement gap related configuration to the CU. Some interaction/coordination procedures for the measurement gap are described below that could improve the current F1 interface. FIGS. 4-11 illustrate examples for the CU/DU communications for the gap measurement. The measurement gap is further described below with respect to FIG. 3.

FIG. 1 shows an example base station 102. The base station may also be referred to as a wireless network node and may be the network nodes (e.g. master node (“MN”), secondary node (“SN”), and the source/target nodes) shown in FIGS. 3A-7B. The base station 102 may be further identified to as a nodeB (NB, e.g., an eNB or gNB) in a mobile telecommunications context. The example base station may include radio Tx/Rx circuitry 113 to receive and transmit with user equipment (UEs) 104. The base station may also include network interface circuitry 116 to couple the base station to the core network 110, e.g., optical or wireline interconnects, Ethernet, and/or other data transmission mediums/protocols.

The base station may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the base station. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

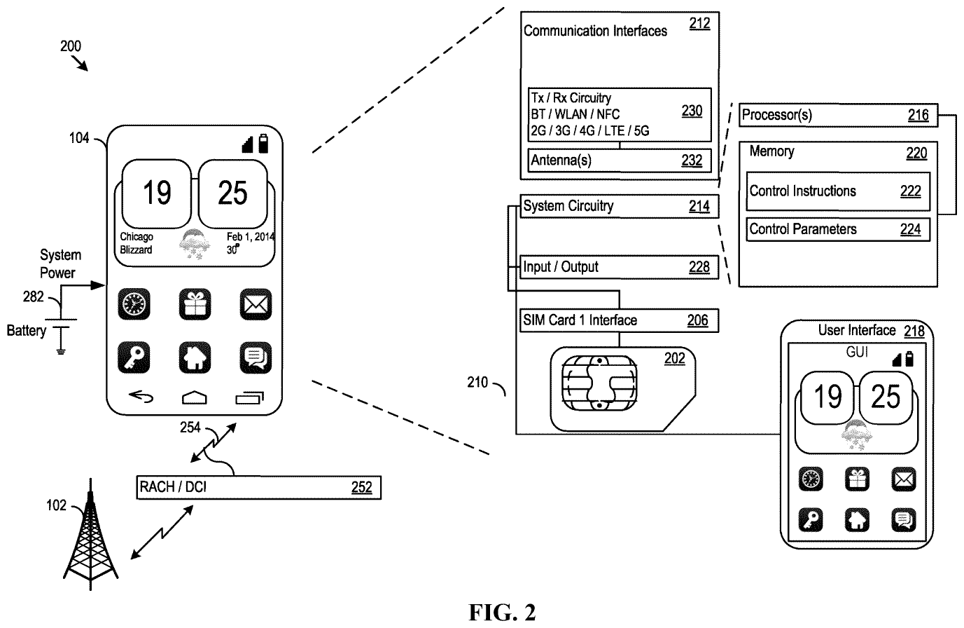

FIG. 2 shows an example random access messaging environment 200. In the random access messaging environment a UE 104 may communicate with a base station 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may the control plane entities and User Plane Function (“UPF”) is the user plane entity in new radio (“NR”) or 5GC. The signaling connection between AMF/SMF and the master node (“MN”) may be a Next Generation-Control Plane (“NG-C”)/MN interface. The signaling connection between MN and SN may an Xn-Control Plane (“Xn-C”) interface. The signaling connection between MN and UE is a Uu-Control Plane (“Uu-C”) RRC interface. All these connections manage the configuration and operation of MR-DC. The user plane connection between User Plane Function (“UPF”) and MN may be NG-U (MN) interface instance.

FIG. 3 shows a network architecture of a base station Central Unit (CU) and base station Distributed Unit (DU). FIG. 3 illustrates base stations (labeled as “gNB”) that communicate with an overall network (labeled “5GC”). Base stations can communicate with one another via a control plane interface (“Xn-C”). One base station is shown as have one CU that is connected to two DUs via an F1 interface. This is merely one example of an arrangement of a base station. In some embodiments, there may be one or any number of DUs connected with a single CU.

The base station can be divided into two physical entities named Centralized Unit (“CU”) and Distributed Unit (“DU”). Generally, the CU may provide support for the higher layers of the protocol stack such as SDAP, PDCP and RRC while the DU provides support for the lower layers of the protocol stack such as RLC, MAC and Physical layer. The CU may include operations for a transfer of user data, mobility control, radio access network sharing, session management, etc., except those functions allocated exclusively to the DU. The DU(s) are logical node(s) with a subset of the base station functions, and may be controlled by the CU.

The CU may be a logical node hosting RRC, SDAP and PDCP protocols of the base station or RRC and PDCP protocols of the base station that controls the operation of one or more DUs. The DU may be a logical node hosting RLC, MAC and PHY layers of the base station, and its operation may be at least partly controlled by the CU. A single DU may support one or multiple cells. However, each cell is only supported by a single DU. Each base station may support many cells.

A measurement gap is a period for a user equipment (UE) to perform measurements at different frequencies. During the gap, there may be no communication and the UE may turn off radios. The UE may measure the neighboring cells signal and/or other carrier components. The measurements may be performed with the same module as used for communication, so there may be a measurement gap. The UE may measure the neighbor signal transmitting on the same frequency while simultaneously transmitting and receiving data from the serving cell. While for measuring cell operating at different frequency (e.g. Inter frequency Neighbors) and Other RAT (LTE is other RAT for 5G NR), the UE may suspended communication (Tx/Rx) with the serving cell and needs to tune the communication module to configured frequencies (e.g. configured Meas Objects) and resume connection with serving cell after the gap, which is the time duration during which the UE suspends communication with a serving cell to measure inter frequency neighbor or other RAT neighbor.

Depending on the UE capability to support independent FR (frequency range) measurement and network preference, there may be two types of measurement gaps. One is per-UE and another is per-FR. In per-FR gap, two independent gap patterns (i.e. FR1 gap and FR2 gap) are defined for FR1 and FR2 respectively. Per-UE gap applies to both FR1 (E-UTRA and NR) and FR2 (NR) frequencies. Frequency range (FR) FR1 is frequency band gap where network stops communication with FR1 cells but still keeps communication with other cells (e.g. FR2). FR2 is frequency band gap where network stops communication with FR2 cells but still keeps communication with other cells (e.g. FR1). In particular, measurement gaps may be periods that the UE may use to perform measurements.

In new radio (NR) or 5G, there may be at least three different configurations (Meas Gap). The first configuration is gapFR1, which is a gap configuration applied to FR1. A second configuration is gapFR2, which is a configuration applied to FR2. Similar to gapFR1, gapFR2 may not be configured together with gapUE. A third configuration is a gapUE. If gapUE is configured, then neither gapFR1 nor gapFR2 can be configured. With this meas gap configuration, UE can measure FR1, FR2 and non NR RAT.

In the CU/DU split example, the CU and the DU may coordinate and interact for the measurement and measurement gap related configuration. The interaction may include a user equipment (UE) Context Setup procedure and/or a UE Context Modification (Base station-CU initiated) procedure in which the CU sends measurement frequencies to the DU. The interactions are further described below.

### UE Context Setup

When the base station centralized unit (CU) includes the SMTC information of the measured frequency (ies) in the MeasurementTimingConfiguration information element (IE) of the CU to DU RRC Information IE that is included in the UE CONTEXT SETUP REQUEST message, the base station distributed unit (DU) shall generate the measurement gaps based on the received SMTC information. The base station DU may send the measurement gaps information to the base station CU in the MeasGapConfig IE of the DU to CU RRC Information IE that is included in the UE CONTEXT SETUP RESPONSE message. IE examples are shown in the Tables below.

When the MeasConfig IE is included in the CU to DU RRC Information IE in the UE CONTEXT SETUP REQUEST message, the base station DU may deduce changes to the measurements configuration to be applied. If the measObjectToAddModList IE is included in the MeasConfig IE, then the frequencies added to—the IE may be activated. The base station DU may decide if measurement gaps are needed. When needed, the base station DU may send the measurement gaps information to the base station CU in the MeasGapConfig IE of the DU to CU RRC Information IE that is included in the UE CONTEXT SETUP RESPONSE message. When the measObjectToRemoveList IE is included in the MeasConfig IE, the base station DU shall ignore it. IE examples are shown in the Tables below.

### UE Context Modification

If the base station CU includes the SMTC information of the measured frequency (ies) in the MeasurementTimingConfiguration IE of the CU to DU RRC Information IE that is included in the UE CONTEXT MODIFICATION REQUEST message, then the base station DU may generate the measurement gaps based on the received SMTC information. The base station DU may send the measurement gaps information to the base station CU in the MeasGapConfig IE of the DU to CU RRC Information IE that is included in the UE CONTEXT MODIFICATION RESPONSE message.

When the MeasConfig IE is included in the CU to DU RRC Information IE in the UE CONTEXT MODIFICATION REQUEST message, the base station DU may deduce that changes to the measurements' configuration need to be applied. The base station DU may take the received info (e.g. the measObjectToAddModList IE, and/or the measObjectToRemoveList IE) into account when generating measurement gap, and when deciding if a measurement gap is needed or not.

### CU to DU RRC Information

TABLE 1
Example of MeasConfig for CU to DU.

| | | | | | | |
|---|---|---|---|---|---|---|
| | | | IE type | | | |
| IE/Group | | | and | | | Assigned |
| Name | Presence | Range | reference | Semantics description | Criticality | Criticality |

| | | | | |
|---|---|---|---|---|
| MeasConfig | O | OCTET | MeasConfig, as defined in TS 38.331 | — |
| | | STRING | [8] (without MeasGapConfig). | |
| | | | For EN-DC/NGEN-DC operation, | |
| | | | includes the list of FR2 frequencies for | |
| | | | which the gNB-CU requests the gNB-DU | |
| | | | to generate gaps. | |
| | | | For NG-RAN, NE-DC and MN for NR-NR DC, | |
| | | | includes the list of FR1 and/or | |
| | | | FR2 frequencies for which the gNB-CU | |
| | | | requests the gNB-DU to generate | |
| | | | gaps and the gap type (per-UE or | |
| | | | per-FR). | |

### DU to CU RRC Information

TABLE 2
Example of MeasConfig for DU to CU.

| | | | | | | |
|---|---|---|---|---|---|---|
| | | | IE type | | | |
| IE/Group | | | and | | | Assigned |
| Name | Presence | Range | reference | Semantics description | Criticality | Criticality |

| | | | |
|---|---|---|---|
| MeasGapConfig | O | OCTET | MeasGapConfig as defined in TS |
| | | STRING | 38.331 [8]. |
| | | | For EN-DC/NGEN-DC operation, |
| | | | includes the gap for FR2, as requested |
| | | | by the gNB-CU via MeasConfig IE. |
| | | | For NG-RAN, NE-DC and MN for NR-NR |
| | | | DC, includes the gap(s) for FR1 |
| | | | and/or FR2, as requested by the |
| | | | gNB-CU via MeasConfig IE and according |
| | | | to the requested gap type (per-UE or |
| | | | per-FR). |

### Gap Type/Purpose

The CU informs/indicates to the DU the requested or allowed gap type or gap purpose or gap pattern. In some examples, the gap type/purpose/pattern may include perUE, perFR1, perFR2, concurrent gap, pre-configured gap, network controlled small gap (NCSG), etc. The requested gap type/purpose/pattern may be a combination of one or more gap types/purposes/patterns. For example, there may be a concurrent gap combined with perUE. In another example, a pre-configured gap may be combined with perUE. In another example, NCSG may be combined with perUE. The measurement gap type and/or measurement gap purpose/pattern may be combined and/or communicated for more efficient communication regarding the measurement gap in the split CU/DU embodiment.

The requested gap type/purpose/pattern may be indicated via one or more indication. For example, there may be an indication for one gap type/purpose/pattern (e.g. per UE, perFR1, per FR2). In another example, there may be an indication for another gap type/purpose/pattern (e.g. concurrent gap, pre-configured gap, NCSG, etc.). The indication (e.g. GapType) may be included as one information element (IE) in a F1-C message (e.g. UE CONTEXT MODIFICATION REQUEST message or UE CONTEXT SETUP REQUEST message). The IE may be included in the DU to CU RRC Information IE within a F1-C message.

TABLE 3
Signaling structure example of gap type.

| IE/Group | | | | Semantics | | Assigned |
|---|---|---|---|---|---|---|
| Name | Presence | Range | IE type and reference | description | Criticality | Criticality |
| GapType | O | | ENUMERATED {perUE, | Indicates | | |
| | | | perFR1, perFR2, concurrent, | the gap | | |
| | | | pre-configured, NCSG, . . . } | type. | | |

### Concurrent Gap

Concurrent gap is one type of a gap and is further described below. There may be multiple concurrent and independent multiple gap patterns. Multiple gap configurations may correspond with UE capability. There may be a mandatory association between gap and dedicated use cases (e.g., PRS, SSB, CSI-RS, EUTRA) by indicting a gap ID in the measurement objective or MG configuration (e.g. for PRS). UE's measurement behavior may be well-defined, because the UE may be required to perform the measurement associated to the gap during that gap occasion. There may be a maximum supported concurrent gap pattern for per-FR gap incapable/capable UEs. For per-FR gap incapable UE, there may be up to two concurrent gap patterns that can be configured. For per-FR gap capable UE, there may be up to three concurrent gap patterns can be configured (e.g. up to two gaps in one FR).

TABLE 4
Gap combination examples.
Combinations of different gap types for per-FR gap capable UE

| | # of simultaneous MG | | | |
|---|---|---|---|---|
| Index | Per-FR1 | Per-FR2 | Per-UE | RAN4 conclusion |
| 0 | 2 | 1 | 0 | Supported |
| 1 | 1 | 2 | 0 | Supported |
| 2 | 0 | 0 | 2 | Supported |
| 3 | 1 | 0 | 1 | Supported when per-UE |
| 4 | 0 | 1 | 1 | gap is associated to PRS |
| 5 | 1 | 1 | 1 | measurement |
| 6 | 0 | 0 | 1 | Supported |
| 7 | 1 | 1 | 0 | Supported |
| 8 | 1 | 0 | 0 | Supported |
| 9 | 0 | 1 | 0 | Supported |
| 10 | 2 | 0 | 0 | Supported |
| 11 | 0 | 2 | 0 | Supported |

There may be a proximity condition of colliding gap occasions. Upon colliding, UE drops the gap with a lower priority level which is configured by network. Data scheduling may be resumed on dropped gap occasion. The corresponding UE requirements regarding gap interruption, measurement delay, and L1 measurement impact may be updated.

As a first issue, the gap measurement communication may need to know which node (DU or CU) decides to configure/use the concurrent gap. In one embodiment, the CU sends an indication to the DU via F1-C message, to indicate that the concurrent gap is requested/allowed. In another embodiment, the DU decides this based on the UE capability. As another issue, there is a decision as to deciding/generating the gap association. There is a determination as to which node (DU or CU) decides the requested or allowed gap or gap combination information, which may include the number of gap patterns or gap combinations, whether the concurrent gap is required, whether the legacy gap (e.g. indicated by GagConfig IE) or/and R17 gap (e.g. indicated by GagConfig-r17 IE) is required, the requested or allowed gap type/purpose/pattern, gap priority, etc. The gap association may associate the measurement object with the measurement gap which is used for SSB or CSI-RS measuring identified by the associated measurement object. The gap association may associate the dedicated use case with the measurement gap. The use case may include at least one of the following: positioning/PRS gap, Multi-Universal Subscriber Identity Module (MUSIM) gap, Non-Terrestrial Network (NTN) gap, gap for SSB measurement, gap for CSI-RS measurement, gap for E-UTRAN measurement, etc.

TABLE 5
Example combinations/options for the CU/DU split.

| | Who decides the gap or gap | Who decides the gap |
|---|---|---|
| Options | combination information? | association? |
| 1 | CU | CU |
| 2 | CU | DU |
| 3 | DU | CU |
| 4 | DU | DU |

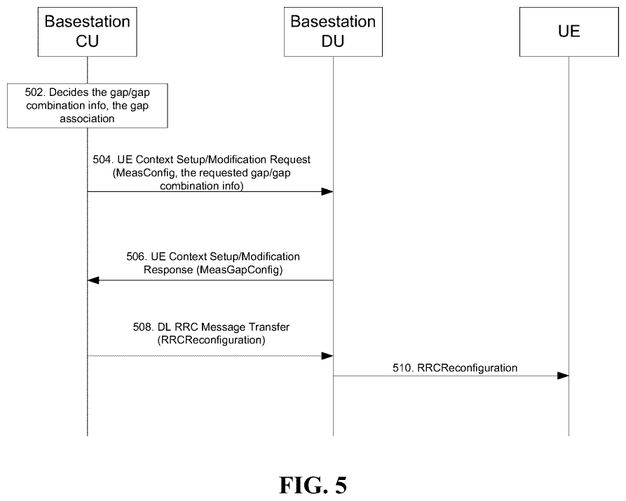

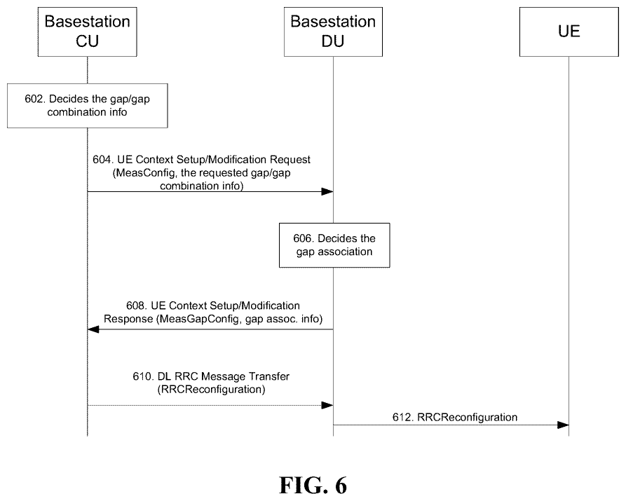

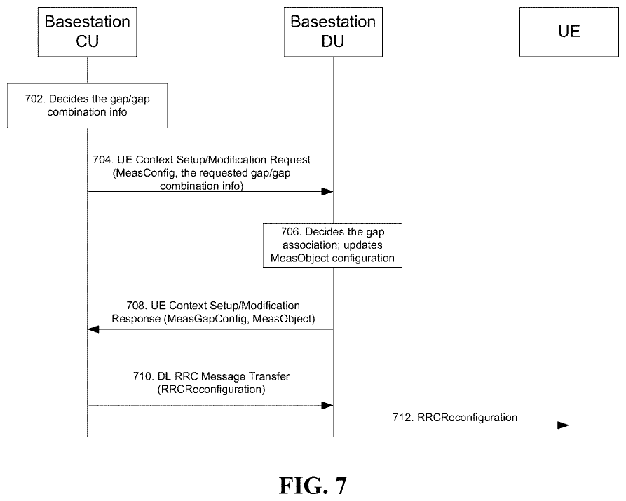

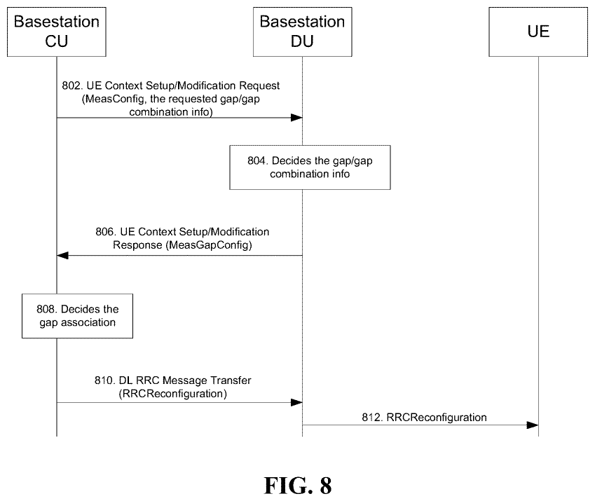

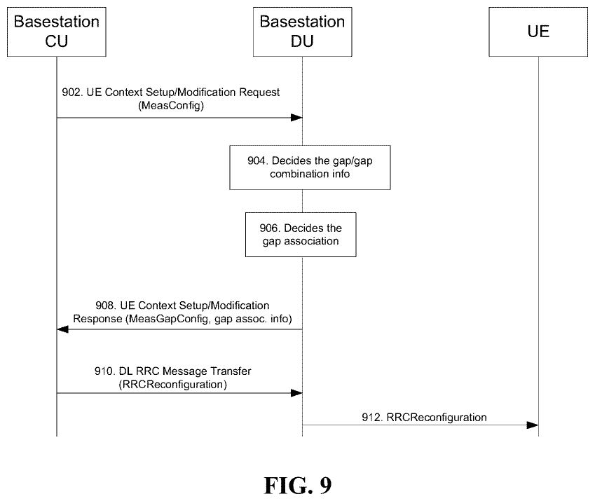

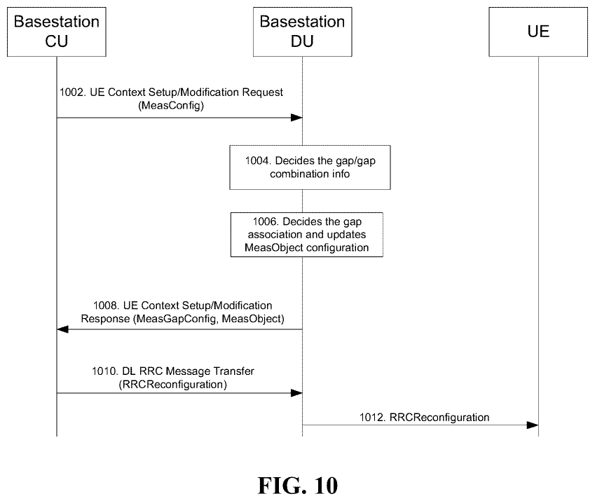

FIGS. 4-11 illustrate embodiments of a split CU and DU for coordination of measurement communications. FIGS. 4-5 show examples of option 1 from Table 5. FIGS. 6-7 show examples of option 2 from Table 5. FIG. 8 shows an example of option 3 from Table 5. FIGS. 9-10 show examples of option 4 from Table 5.

FIG. 4 shows one embodiment of communications for a split embodiment of a Distributed Unit (DU) and Centralized Unit (CU). In this example, the centralized unit (CU) decides the gap or gap combination information and the CU decides the gap association. In block 402, the base station CU decides the gap or gap combination information initially. In block 404, the CU sends the configured frequencies (e.g. via MeasConfig), the requested gap or gap combination information to the DU via F1-C message (e.g. UE CONTEXT SETUP/MODIFICATION REQUEST message). In block 406, the DU generates measurement (“meas”) gap configurations. This may include legacy gap and/or R17 gap and is based on the requested/indicated gap or gap combination information from the CU. The DU sends the generated measurement gap configurations to the CU via F1-C message, e.g. UE CONTEXT SETUP/MODIFICATION RESPONSE message. In block 408, the CU decides the gap association between measObjects and measurement gaps, based on the received measurement gap configurations. The CU re-configures the measObject configuration to link the measurement gap ID with the measurement object. This may include associatedMeasGapSSB/associatedMeasGapCSIRS into MeasObjectNR, and/or including associatedMeasGap into MeasObjectEUTRA. In block 410, the CU generates the RRC reconfiguration message including the measurement configuration (e.g. MeasConfig). The measurement configuration may include at least one of the following measurement object configuration (e.g. MeasObject), measurement ID (e.g. MeasId), measurement report configuration (e.g. MeasReport), or measurement gap configuration (e.g. MeasGapConfig). The CU sends the generated RRC reconfiguration message to the UE through the DU in block 412. The UE uses this information to perform measurements on different frequencies.

FIG. 5 shows another embodiment of communications for a split embodiment of a Distributed Unit (DU) and Centralized Unit (CU). In this example, the centralized unit (CU) decides the gap or gap combination information and the CU decides the gap association. In FIG. 4, the CU decides/generates the gap association after the DU measurement gap configuration. In FIG. 5, the timing of the gap association decision/generation is different from FIG. 4.

In block 502, the CU decides the gap association between measObjects and measurement (“meas”) gaps. The CU may already have frequency information (e.g. including which frequencies are used for measurements) or/and measurement use cases information (e.g. the measurement is used for positioning reference signal (PRS) measurement). In this example, the CU pre-decides the gap association. In block 504, the CU sends the configured frequencies (e.g. via MeasConfig), the pre-defined gap association or/and the requested gap or gap combination to the DU via F1-C message (e.g. UE CONTEXT SETUP/MODIFICATION REQUEST message). The pre-defined gap association may be indicated implicitly (e.g. including the pre-assigned meas measurement gap ID into the measObject within MeasConfig) or explicitly (e.g. including the gap association information directly in the F1-C message). In block 506, the DU generates measurement gap configurations, based on the requested/indicated gap or gap combination information, and/or the gap association information from the CU. The DU sends measurement gap configurations to the CU via F1-C message (e.g. UE CONTEXT SETUP/MODIFICATION RESPONSE message). For some measurement gaps (e.g. configured via GapConfig-r17), the DU includes the gap ID pre-assigned by the CU into the gap configuration. In block 508, he CU generates RRC reconfiguration message including the measurement configuration (e.g. MeasConfig). The measurement configuration may include at least one of the following measurement object configuration (e.g. MeasObject), measurement ID (e.g. MeasId), measurement report configuration (e.g. MeasReport), or measurement gap configuration (e.g. MeasGapConfig). The CU sends the generated RRC reconfiguration message to the UE through the DU in block 510.

FIG. 6 shows another embodiment of communications for a split embodiment of a Distributed Unit (DU) and Centralized Unit (CU). FIGS. 6-7 show examples of option 2 from Table 5. In the example shown in FIG. 6, the centralized unit (CU) decides the gap or gap combination information and the distributed unit (DU) decides the gap association. The DU generates the gap association and sends it to the CU. The CU re-configures the measObject.

In block 602, the base station CU decides the gap or gap combination information. In block 604, the CU sends the configured frequencies (e.g. via MeasConfig), the requested gap or gap combination information to the DU via F1-C message (e.g. UE CONTEXT SETUP/MODIFICATION REQUEST message). In block 604, the DU generates measurement (“meas”) gap configurations, which may include legacy gap and/or R17 gap. In block 606, the DU decides the gap association (e.g. a list of gap ID, each one linked with the associated SSB/CSI-RS frequencies or measObject IDs), based on the requested gap information from the CU. In block 608, the DU sends meas measurement gap configurations and the gap association information to the CU via F1-C message (e.g. UE CONTEXT SETUP/MODIFICATION RESPONSE message). The CU re-configures the measObject configuration to link the measurement object with the associated measurement gap ID, based on the gap association information from the DU. In block 610, the CU generates RRC reconfiguration message including the measurement configuration (e.g. MeasConfig). The measurement configuration may include at least one of the following measurement object configuration (e.g. MeasObject), measurement ID (e.g. MeasId), measurement report configuration (e.g. MeasReport), or measurement gap configuration (e.g. MeasGapConfig). The CU sends the generated RRC reconfiguration message to the UE through the DU in block 612.

FIG. 7 shows another embodiment of communications for a split embodiment of a Distributed Unit (DU) and Centralized Unit (CU). In the example shown in FIG. 7, the centralized unit (CU) decides the gap or gap combination information and the distributed unit (DU) decides the gap association. In FIG. 7, the timing of the gap association decision/generation is different from FIG. 6. The DU directly re-configures/updates the measObject, and then sends the updated measObject configuration to the CU. In block 702, the base station CU decides the gap or gap combination information. In block 704, the CU sends the configured frequencies (e.g. MeasConfig), the requested gap information to the DU via F1-C message (e.g. UE CONTEXT SETUP/MODIFICATION REQUEST message). In block 706, the DU generates measurement (“meas”) gap configurations, which may include legacy gap and/or R17 gap. The DU decides the gap association, based on the requested gap information from the CU. The DU re-configures/updates the measObject configuration to link the measurement object with the associated measurement gap ID. In block 708, the DU sends measurement gap configurations and updated measObject configuration to the CU via F1-C message (e.g. UE CONTEXT SETUP/MODIFICATION RESPONSE message). In block 710, the CU generates RRC reconfiguration message including the measurement configuration (e.g. MeasConfig). The measurement configuration may include at least one of the following measurement object configuration (e.g. MeasObject), measurement ID (e.g. MeasId), measurement report configuration (e.g. MeasReport), or measurement gap configuration (e.g. MeasGapConfig). The CU sends the generated RRC reconfiguration message to the UE through the DU in block 712.

FIG. 8 shows another embodiment of communications for a split embodiment of a Distributed Unit (DU) and Centralized Unit (CU). FIG. 8 shows an example of option 3 from Table 5. In the example shown in FIG. 8, the distributed unit (DU) decides the gap or gap combination information and the centralized unit (CU) decides the gap association. The DU decides the gap or gap combination information and the CU decides the gap association. In block 802, the CU sends the configured frequencies (e.g. via MeasConfig), and/or concurrent gap request indication to the DU via F1-C message (e.g. UE CONTEXT SETUP/MODIFICATION REQUEST message). In block 804, the DU decides the gap or gap combination information. In block 806, the DU generates multiple measurement (“meas”) gap configurations, which may include legacy gap and/or R17 gap. The DU sends measurement gap configurations to the CU via F1-C message (e.g. UE CONTEXT SETUP/MODIFICATION RESPONSE message). In block 808, the CU decides the gap association between measObjects and measurement gaps, based on the received measurement gap configurations. The CU re-configures the measObject configuration to link the measurement gap ID with the measurement object (e.g. including associatedMeasGapSSB/associatedMeasGapCSIRS into MeasObjectNR, and/or including associatedMeasGap into MeasObjectEUTRA). In block 810, the CU generates the RRC reconfiguration message including the measurement configuration (e.g. MeasConfig). The measurement configuration may include at least one of the following measurement object configuration (e.g. MeasObject), measurement ID (e.g. MeasId), measurement report configuration (e.g. MeasReport), or measurement gap configuration (e.g. MeasGapConfig). The CU sends the generated RRC reconfiguration message to the UE through the DU in block 812.

FIG. 9 shows another embodiment of communications for a split embodiment of a Distributed Unit (DU) and Centralized Unit (CU). FIGS. 9-10 show examples of option 4 from Table 5. In the example shown in FIG. 9, the distributed unit (DU) decides the gap or gap combination information and the DU decides the gap association. In FIG. 9, the timing of the gap association decision/generation is different from FIG. 8. The DU generates the gap association and sends it to the CU and then the CU re-configures the measObject. In block 902, the CU sends the configured frequencies (e.g. via MeasConfig), and/or concurrent gap request indication to the DU via F1-C message (e.g. UE CONTEXT SETUP/MODIFICATION REQUEST message). In block 904, the DU generates multiple measurement (“meas”) gap configurations that may include legacy gap and/or R17 gap. The gap association (e.g. a list of gap ID, each one linked with the associated SSB/CSI-RS frequencies or measObject IDs) may be based on the requested gap information from the CU. In block 906, the DU decides the gap association. In block 908, the DU sends measurement gap configurations and the gap association information to the CU via F1-C message (e.g. UE CONTEXT SETUP/MODIFICATION RESPONSE message). The CU re-configures the measObject configuration to link the measurement gap ID with the associated measurement object, based on the gap association information from the DU. In block 910, the CU generates RRC reconfiguration message including the measurement configuration (e.g. MeasConfig). The measurement configuration may include at least one of the following measurement object configuration (e.g. MeasObject), measurement ID (e.g. MeasId), measurement report configuration (e.g. MeasReport), or measurement gap configuration (e.g. MeasGapConfig). The CU sends the generated RRC reconfiguration message to the UE through the DU in block 912.

FIG. 10 shows another embodiment of communications for a split embodiment of a Distributed Unit (DU) and Centralized Unit (CU). In the example shown in FIG. 10, the distributed unit (DU) decides the gap or gap combination information and the DU decides the gap association. The DU directly re-configures/updates the measObject, and then sends the updated measObject configuration to the CU. In block 1002, the CU sends the configured frequencies (e.g. MeasConfig), and/or concurrent gap request indication to the DU via F1-C message (e.g. UE CONTEXT SETUP/MODIFICATION REQUEST message). In block 1004, the DU generates measurement (“meas”) gap configurations which may include legacy gap and/or R17 gap. The DU decides the gap association. The DU re-configures the measObject configuration to link the measurement object with the associated measurement gap ID. In block 1006, the DU decides the gap association and updates the MeasObject configuration. In block 1008, the DU sends measurement gap configurations and updated measObject configuration to the CU via F1-C message (e.g. UE CONTEXT SETUP/MODIFICATION RESPONSE message). In block 1010, the CU generates a RRC reconfiguration message including the measurement configuration (e.g. MeasConfig). The measurement configuration may include at least one of the following measurement object configuration (e.g. MeasObject), measurement ID (e.g. MeasId), measurement report configuration (e.g. MeasReport), or measurement gap configuration (e.g. MeasGapConfig). The CU sends the generated RRC reconfiguration message to the UE through the DU in block 1012.

The examples shown in FIGS. 4-10 are for a gap type with concurrent gaps. The gap or gap combination information may include at least one of the requested/allowed number of gap types/purposes/patterns, the requested/allowed gap combination, an indication to indicate whether the legacy gap, gap priority information, measured frequencies priority information, or requested/allowed gap type/purpose/pattern. The requested/allowed number of gap types/purposes/patterns may include: 1) a total or maximum number for gap types/purposes/patterns allowed to be configured by the DU; or 2) for each gap type/purpose/pattern, a requested or maximum number of gap types/purposes/patterns allowed to be configured by the DU (e.g. at most 2 perFR1 gap and 1 perFR2 gap). The requested/allowed gap combination may include: 1) a bit string/bitmap with each position in the bit string/bitmap indicating whether the corresponding gap combination in the RAN4-defined table (e.g. Table-5) is requested or not (e.g. value 1 indicates the corresponding gap combination is requested/allowed, or vice versa); or 2) one or a list of gap combination index that is allowed to be used/configured by the DU (e.g. value 1 indicates the first gap combination in the RAN4-defined table (e.g. Table-5) while value 2 indicates the second gap combination in the RAN4-defined table (e.g. Table-5)).

Another example is the indication to indicate whether the legacy gap (e.g. GagConfig) and/or R17 gap (e.g. GapConfig-r17) is requested/allowed to be configured by the DU. Another example is the gap priority information to be used by each measurement gap, which may include one or a list of gap priority for the gap used for different features/uses cases (e.g. positioning/PRS gap, MUSIM gap, NTN gap, gap for SSB measurement, gap for CSI-RS measurement, gap for E-UTRAN measurement, etc.). In some embodiments, a list of gap feature/use case (each one is linked with a gap priority value), where the priority value for each gap is indicated as an integer (e.g. value 1 indicates highest priority, value 2 indicates second level priority, etc.). The gap with highest priority may be used or the gap priority may be associated with gap features/use cases. The gap priority indication or indicator may be used to indicate which gap has high priority. The gap priority may also include one or a list of gap priority for the gap for associated frequencies or measObject measurement. For example, a list of SSB/CSI-RS frequencies may be linked with a gap priority value. The priority value for each gap may be indicated as an integer (e.g. value 1 indicates highest priority, value 2 indicates second level priority, etc.).

Another example includes the measured frequencies priority information may be indicated as a list of frequencies or measObjects ranked from high priority to low priority. The receiving node may use this information to generate the gap priority for a gap that is used to measure the corresponding frequencies or measObjects. This may be similar to a gap priority for frequencies, where there is a priority for different frequency values.

Another example is the indication to indicate one or more requested or allowed gap type/purpose/pattern (e.g. perUE, perFR1, perFR2).

Another example is the indication to indicate whether the concurrent gap is requested/allowed (e.g. “Concurrent Gap Indicator”).

A negotiation procedure may be considered for gap or gap combination information coordination between the CU and the DU. The CU sends the suggested gap or gap combination information to the DU. The DU selects one of the gap or gap combination information suggested by the CU, to generate measurement gap configurations. Then if the DU wants to request other gap or gap combination, the DU can send the requested gap or gap combination information to the CU.

The gap association may be indicated as: 1) a list of gap ID, each gap ID links with one or a list of MeasObjec IDs to be associated with the corresponding gap; 2) a list of gap ID, each gap ID links with one or a list of SSB/CSI-RS frequencies to be associated with the corresponding gap; or 3) a list of MeasObject IDs, each one links with one or more gap IDs to be associated with the corresponding MeasObject. For example, for E-UTRAN MeasObject, one MeasObject is associated with one gap ID; for NR MeasObject, one MeasObject is associated with one or more gap ID (e.g. one gap ID associated with SSB measurement, the other gap ID associated with CSI-RS measurement). A fourth example may include a list of SSB/CSI-RS frequencies, where each one links with one or more gap IDs to be associated with the corresponding frequencies. A fifth example may include a list of gap ID, each gap ID links with one or more uses cases to be associated with the corresponding gap. A sixth example may include a list of uses cases, each use case links with one or a list of gap IDs.

Examples of signaling structure for the gap or gap combination are shown in the following table:

TABLE 6
Examples of signaling structure for the gap or gap combination.

| IE/Group | | | IE type and | | | Assigned |
|---|---|---|---|---|---|---|
| Name | Presence | Range | reference | Semantics description | Criticality | Criticality |
| Gap | O | | BIT STRING | Indicates the | | |
| Combination | | | (SIZE(12)) | allowed/requested gap | | |
| Information | | | | combination as defined | | |
| | | | | in Table 9.1.8-1 in TS | | |
| | | | | 38.133 [38]. | | |
| Gap | O | | ENUMERATED | Indicates whether the | | |
| Config | | | (GapConfig, | GapConfig, GapConfig- | | |
| Type | | | GapConfig-r17, | r17, or both is used for | | |
| | | | both, . . . ) | the gap configuration. | | |

Examples of signaling structure for the gap association information are shown in the following table:

TABLE 7
Examples of signaling structure for the gap association information.

| | | | IE type and | Semantics | | Assigned |
|---|---|---|---|---|---|---|
| IE/Group Name | Presence | Range | reference | description | Criticality | Criticality |
| Gap Association | | 0..1 | | | YES | ignore |
| Information List | | | | | | |
| >Gap Association | | 1.. | | | EACH | ignore |
| Item IEs | | <maxnoofGaps> | | | | |
| >>Measurement Gap | M | | INTEGER | Gap Identifier | — | |
| ID | | | (1..8) | | | |
| >>Gap Mapped to | | 1.. | | | — | |
| MeasObject Item | | <maxnoofMeas- | | | | |
| | | Objects> | | | | |
| >>>MeasObject ID | M | | INTEGER | Measurement | — | |
| | | | (1..64) | Object Identifier | | |

Additional examples of signaling structure for the gap association information are shown in the following table:

TABLE 8
Additional examples of signaling structure
for the gap association information.

| Range bound | Explanation |
|---|---|
| maxnoofGaps | Maximum no. of Gaps allowed towards one UE, |
| | the maximum value is 8. |
| maxnoofMeasObjects | Maximum no. of measurement objects allowed |
| | towards one UE, the maximum value is 64. |

Additional examples of signaling structure for the gap association information are shown in the following table:

TABLE 9
Additional examples of signaling structure for the gap association information.

| | | | IE type | | | |
|---|---|---|---|---|---|---|
| | | | and | Semantics | | Assigned |
| IE/Group Name | Presence | Range | reference | description | Criticality | Criticality |
| Gap Association | | 0..1 | | | YES | ignore |
| Information List | | | | | | |
| >Gap Association Item | | 1.. | | | EACH | ignore |
| IEs | | <maxnoofMeas- | | | | |
| | | Objects> | | | | |
| >>MeasObject ID | M | | INTEGER | Measurement | — | |
| | | | (1..64) | Object Identifier | | |
| >>CHOICE MeasObject | M | | | | — | |
| Mapped to Gap | | | | | | |
| >>>MeasObject | M | | | | — | |
| Mapped to Gap | | | | | | |
| >>>>Associated | O | | INTEGER | Gap Identifier | — | |
| Measurement SSB Gap | | | (1..8) | | | |
| ID | | | | | | |
| >>>>Associated | O | | INTEGER | Gap Identifier | — | |
| Measurement CSI-RS | | | (1..8) | | | |
| Gap ID | | | | | | |
| >>>E-UTRAN | M | | | | — | |
| MeasObject Mapped to | | | | | | |
| Gap | | | | | | |
| >>>>Associated | M | | INTEGER | Gap Identifier | — | |
| Measurement Gap ID | | | (1..8) | | | |

Additional examples of signaling structure for the gap association information are shown in the following table:

TABLE 10
Additional examples of signaling structure
for the gap association information.

| Range bound | Explanation |
|---|---|
| maxnoofGaps | Maximum no. of Gaps allowed towards one UE, |
| | the maximum value is 8. |
| maxnoofMeasObjects | Maximum no. of measurement objects allowed |
| | towards one UE, the maximum value is 64. |

The gap related information above (e.g. the gap or gap combination information, the gap association information) may be transferred between the CU and the DU by at least one of the following options:
Option 1: Include the gap related information directly as information element(s) in a F1-C message (e.g. UE CONTEXT SETUP/MODIFICATION REQUEST message or UE CONTEXT SETUP/MODIFICATION RESPONSE message). The information element(s) may be included in the CU to DU RRC Information IE and/or the DU to CU RRC Information IE within a F1-C message.
Option 2: Include the gap related information encapsulated as an OCTET STRING/container in a F1-C message (e.g. UE CONTEXT SETUP/MODIFICATION REQUEST message or UE CONTEXT SETUP/MODIFICATION RESPONSE message). The OCTET STRING/container may be included in the CU to DU RRC Information IE and/or the DU to CU RRC Information IE within a F1-C message.

### Pre-Configured Gap

In another gap type, the measurement gap may be pre-configured by the network. There may be a pre-configured MG pattern(s). In one embodiment, it may be network controlled, or in another embodiment, it may be a user equipment (UE) autonomous mechanism. It may include multiple activation/de-activation mechanisms and corresponding UE capabilities to support these mechanisms. For a network controlled mechanism, in which UE follows the per-bandwidth part (BWP) indications in active serving cell and per-cell indications in deactivated serving cells to decide the ON/OFF status of the pre-configured MG.

For the UE autonomous mechanism, the UE may follow defined rules (e.g. in TS38.133) to decide the ON/OFF status of the pre-configured MG. If MG is not needed for all measurements, the pre-configured gap may be deactivated (OFF). Otherwise, the pre-configured gap may be activated (ON). Events that may trigger the UE to re-check the ON/OFF status includes:
DCI/Timer based BWP switching;
activation/de-activation of SCell(s);
addition/removal of any measurement object(s);
addition/release/change of a Scell under CA;
BWP switching by RRC; or
initiation of LocationMeasurementIndication.

There may be an additional delay for pre-configured MG activation/deactivation which may be five milliseconds (ms) on top on the legacy procedure delay that may trigger pre-configured MG status change. There may be an update of the corresponding UE requirements regarding gap interruption, measurement delay, and/or L1 measurement impact.

For the pre-configured gap, there may be a first issue for determining which node decides to configure/use the pre-configured gap. In one embodiment, the CU may decide to configure/use the pre-configured gap. In one example, the CU decides whether the pre-configured gap is to be used, and which type of pre-configured gap mechanism is to be used. The CU sends an indication to the DU to indicate whether the pre-configured gap is requested/allowed (e.g. “Pre-configured Gap Indicator”) or/and which type of pre-configured gap mechanism is to be used (e.g. “Pre-configured Gap Mechanism” indication, the value can be set as “Network controlled mechanism”, or “UE autonomous mechanism”) via F1-C message. In another example, the CU decides whether the pre-configured gap is to be used, while the DU decides which type of pre-configured gap mechanism is to be used. In another embodiment, the DU may decide to configure/use the pre-configured gap. The DU may decide this based on the UE capability.

For the pre-configured gap, there may be a second issue for determining how to generate the pre-configured gap. The DU generates the pre-configured gap (e.g. including preConfigInd in GapConfig-r17). This may be according to the pre-configured gap indication from the CU or based on a decision by itself. If the mechanism is network controlled, the DU may directly configure the preConfGapStatus in the BWP/SCell configuration (without interaction with the CU), considering that it is up to the DU to generate both the meas measurement gap configuration and the BWP/SCell configuration. The DU sends the measurement (“meas”) gap configuration, and/or BWP/SCell configuration to the CU via F1-C message. The CU generates the RRC reconfiguration message (including measurement gap configuration, or/and BWP/SCell configuration) and sends the messages to the UE.

### Network Controlled Small Gap (NCSG)

NCSG may be a UE capability reporting based on RRCReconfigurationComplete and RRCResumeComplete messages (similar to NeedforGap). UE can report whether to support ‘no-gap-no-interruption’, ‘ncsg’ or ‘gap’ for each target band to be measured based on UE's current CA configuration. There may twenty-four NCSG patterns with visible interruption (VIL1 and VIL2, which are 1 ms for FR1 and 0.75 ms for FR2) before and after the measurement length (ML). The UE may be expected to continue download (DL) reception or upload (UL) transmission with serving cells during measurement length.

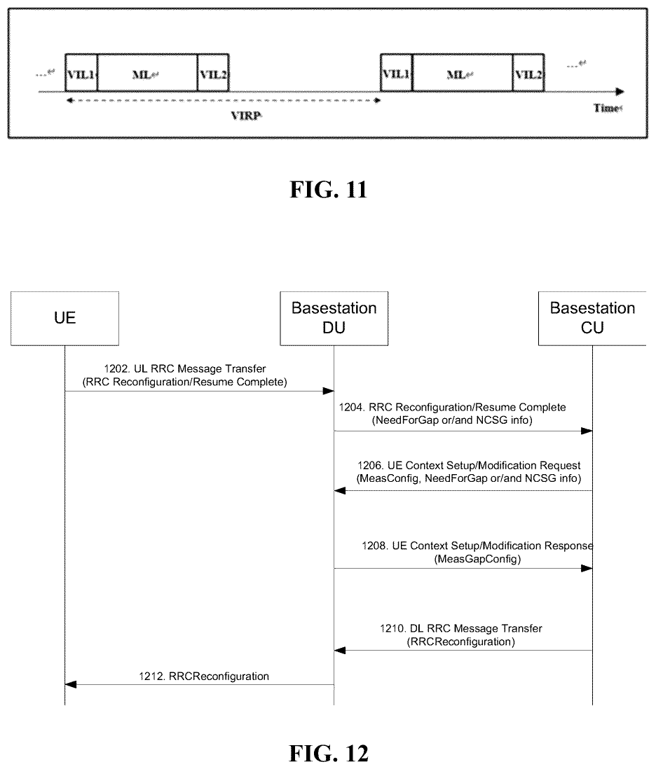

FIG. 11 shows a measurement gap timing example. This may include a MG timing advance of 0.75 ms.

The UE may have behaviors for the cases when UE reports different capabilities on ‘no-gap-no-interruption’, ‘ncsg’ or ‘gap’ but with a different a network configuration (NCSG or legacy MG) which may differ from the UE's reported capability. There may be a synchronization indication between the target NR band to be measured and a reference serving cell of UE to reduce the OFDM symbols restricted from data scheduling, when UE is incapable for simultaneous transmission/reception (Tx/Rx) or independent beamforming (FR2-specific). There may be a corresponding UE requirement regarding gap interruption, scheduling restriction and measurement delay as well as an update for the impact to L1 measurements.

The configuration or usage of the NCSG may be by the centralized unit (CU) base station in one embodiment, or by the distributed unit (DU) base station in another example. For the CU example, the CU may send an indication to the DU via F1-C message, to indicate whether the NCSG is requested/allowed (e.g. “NCSG Indicator”). For the DU example, the DU decides based on the UE capability.

In some embodiments, the CU may need to transfer the received NeedForGap and/or NCSG information to the DU. The CU transfers the NeedForGap and/or NCSG information to the DU via F1-C message, to indicate whether the measurement gap or NCSG is required for the UE to perform measurements on a target band. The NeedForGap and/or NCSG information may be encapsulated as an OCTET STRING/container in a F1-C message.

In one example, there may be a NeedForGapNCSG-InfoNR IE, NeedForGapNCSG-InfoEUTRA IE, and/or NeedForGapsInfoNR IE in CU to DU RRC Information IE within F1-C message (e.g. UE CONTEXT SETUP/MODIFICATION REQUEST message). The IE NeedForGapNCSG-InfoNR may indicate whether the measurement gap or NCSG is required for the UE to perform SSB based measurements on an NR target band while NR-DC or NE-DC is not configured. The IE NeedForGapNCSG-InfoEUTRA indicates whether measurement gap or NCSG is required for the UE to perform measurements on an E UTRA target band while NR-DC or NE-DC is not configured. The IE NeedForGapsInfoNR indicates whether measurement gap is required for the UE to perform SSB based measurements on an NR target band while NR-DC or NE-DC is not configured.

FIG. 12 shows an embodiment of communications for a split embodiment of a Distributed Unit (DU) and Centralized Unit (CU). The network may configure NCSG information to UE with different target bands. In block 1202, the UE sends the RRC Reconfiguration/Resume Complete message to the DU—in block 1202 and to the CU in block 1204. The message includes the NeedForGap and/or NCSG information to indicate whether measurement gap or NCSG is required for the UE to perform measurements on a target band. In block 1206, the CU sends configured frequencies (e.g. via MeasConfig), and/or the NeedForGap and/or NCSG information to the DU via F1-C message, e.g. UE CONTEXT SETUP/MODIFICATION REQUEST message. In block 1208, the DU generates measurement gap configurations, according to the received frequencies (e.g. MeasConfig), and/or the NeedForGap and/or NCSG information. The DU sends measurement gap configurations to the CU via F1-C message, e.g. UE CONTEXT SETUP/MODIFICATION RESPONSE message. In block 1210, the CU generates RRC reconfiguration message including the measurement configuration (including MeasGapConfig) and sends the generated RRC reconfiguration message to the UE through the DU in block 1212.

The following table illustrates examples for signaling structure on NeedForGap or/and NCSG information:

TABLE 11
Example signaling structure on NeedForGap or/and NCSG information

| | | | IE type | | | |
|---|---|---|---|---|---|---|
| IE/Group | | | and | | | Assigned |
| Name | Presence | Range | reference | Semantics description | Criticality | Criticality |
| NeedForGap | O | | OCTET | NeedForGapNCSG- | | |
| NCSG- | | | STRING | InfoNR, as defined in TS | | |
| InfoNR | | | | 38.331 [8]. | | |
| NeedForGap | O | | OCTET | NeedForGapNCSG- | | |
| NCSG- | | | STRING | InfoEUTRA, as defined | | |
| InfoEUTRA | | | | in TS 38.331 [8]. | | |
| NeedForGaps- | O | | OCTET | NeedForGapsInfoNR, | | |
| InfoNR | | | STRING | as defined in TS 38.331 | | |
| | | | | [8]. | | |

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

I/We claim:

1. A method for wireless communication, comprising:
sending a request message with a gap information; and
receiving a response message with a gap configuration based on the gap information.

2. The method of claim 1, wherein the sending is from a base station centralized unit (CU) to a base station distributed unit (DU), and the response message is received by the base station CU from the base station DU.

3. The method of claim 1, wherein the gap information comprises a period that a user equipment (UE) uses to perform measurements or operations with a dedicated use case.

4. The method of claim 1, wherein the request message comprises a user equipment (UE) context setup request message or a UE context modification request message, wherein the response message comprises a UE context setup response message or a UE context modification response message.

5. The method of claim 1, wherein the gap information comprises a requested or allowed gap type, a requested or allowed gap purpose, a requested or allowed gap pattern, a requested or allowed number of gap patterns, a requested or allowed gap combination information, or a gap priority information.

6. The method of claim 5, wherein the requested or allowed gap type comprises at least one of the following: a concurrent gap, a pre-configured gap, or a network controlled small gap (NCSG),
wherein the requested or allowed gap purpose or gap pattern comprises at least one of the following: a per frequency range (FR) 1 gap, a per FR2 gap or a per UE gap,
wherein the requested or allowed gap combination information comprises at least one of the following: a bit string, a bitmap, or at least one gap combination index,
wherein each position in the bit string or the bitmap indicates whether the corresponding gap combination is requested or not, and
wherein the gap priority information comprises at least one of the following: one or a list of gap priorities for a gap associated with a dedicated use case, or one or a list of gap priorities for the gap used for an associated measurement frequency or a measurement object.

7. The method of claim 1, wherein the gap information comprises at least one of a need for the gap information or a need for a network controlled small gap (NCSG) information, to indicate whether a measurement gap or a NCSG is required for a User Equipment (UE) to perform measurements on a target band, and
wherein the need for the gap information and the NCSG information is encapsulated as an OCTET STRING or a container within the request message.

8. The method of claim 2, further comprising one of following:
determining, by the base station CU, a gap association based on the gap configuration; or
receiving, by the base station CU from the base station DU, the gap association, wherein the gap association is determined by the base station DU based on the gap configuration,
wherein the gap association is for at least one of the following: a measurement gap associated with a measurement object, or a measurement gap associated with a dedicated use case.

9. A method for wireless communication comprising:
receiving a request message with a gap information; and
transmitting a response message with a gap configuration based on the gap information.

10. The method of claim 9, wherein the receiving is by a base station distributed unit (DU) from a base station centralized unit (CU), and the transmitting is from the base station DU to the base station CU.

11. The method of claim 10, wherein the gap information comprises a period that a user equipment (UE) uses to perform measurements or operation with a dedicated use case.

12. The method of claim 9, wherein the request message comprises a user equipment (UE) context setup request message or a UE context modification request message, wherein the response message comprises a UE context setup response message or a UE context modification response message.

13. The method of claim 9, wherein the gap information comprises a requested or allowed gap type, a requested or allowed gap purpose, a requested or allowed gap pattern, a requested or allowed number of gap patterns, a requested or allowed gap combination information, or a gap priority information.

14. The method of claim 13, wherein the requested or allowed gap type comprises at least one of the following: a concurrent gap, a pre-configured gap, or a network controlled small gap (NCSG),
wherein the requested or allowed gap purpose or gap pattern comprises at least one of the following: a per frequency range (FR) 1 gap, a per FR2 gap, or a per UE gap,
wherein the requested or allowed gap combination information comprises at least one of: a bit string, a bitmap, or at least one gap combination index,
wherein each position in the bit string or the bitmap indicates whether the corresponding gap combination is requested or not, and
wherein the gap priority information comprises at least one of the following: one or a list of gap priority for the gap associated with a dedicated use case; one or a list of gap priority for the gap used for an associated measurement frequency or a measurement object.

15. The method of claim 9, wherein the gap information comprises at least one of a need for the gap information or a need for a network controlled small gap (NCSG) information, to indicate whether a measurement gap or a NCSG is required for a user equipment (UE) to perform measurements on a target band, and
wherein the need for the gap information and the NCSG information is encapsulated as an OCTET STRING or a container within the request message.

16. The method of claim 10, wherein
a gap association is determined by the base station CU based on the gap configuration; or
the gap association is determined by the base station DU based on the gap configuration, and sent by the base station DU to the base station CU, and
wherein the gap association is for at least one of the following: a measurement gap associated with a measurement object, or a measurement gap associated with a dedicated use case.

17. A wireless communications apparatus comprising a processor and a memory, wherein the processor is configured to read code from the memory and implement a method comprising:
sending a request message with a gap information; and
receiving a response message with a gap configuration based on the gap information.

18. A non-transitory computer-readable program medium having codes stored thereon, the codes, when executed by a processor, causing the processor to implement a method recited in claim 1.

19. A wireless communications apparatus comprising a processor and a memory, wherein the processor is configured to read code from the memory and implement a method comprising:
receiving a request message with a gap information; and
transmitting a response message with a gap configuration based on the gap information.

20. A non-transitory computer-readable program medium having codes stored thereon, the codes, when executed by a processor, causing the processor to implement a method recited in claim 9.
